(19) United States
(12) Patent Application Publication
(10) Pub. No.: US 2024/0015181 A1
(43) Pub. Date: Jan. 11, 2024

(54) SYSTEMS AND METHODS FOR SECURITY ENHANCED DOMAIN CATEGORIZATION

(71) Applicant: Fortinet, Inc., Sunnyvale, CA (US)

(72) Inventor: Jochen Pretli, Frankfurt (DE)

(73) Assignee: Fortinet, Inc., Sunnyvale, CA (US)

(21) Appl. No.: 17/859,148

(22) Filed: Jul. 7, 2022

(51) Int. Cl. H04L 9/40

(52) U.S. Cl. CPC H04L 63/1483; H04L 63/1433; H04L 63/145

(57) ABSTRACT

Systems, devices, and methods are discussed for mitigating security threats due to web-domain characteristic changes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2021, Fortinet, Inc.

### FIELD

Embodiments discussed generally relate to performing web filtering by a security application, and more particularly to systems and methods for mitigating security threats due to web-domain characteristic changes.

### BACKGROUND

Processing Internet communications may include determining from which web-domain the communications derive, and basing security protocols based upon the web-domain. Over time a database of web-domains may be developed that indicate whether a given domain is safe, unknown, or malicious, and security protocols may be selected depending upon how the web-domain is categorized. Such an approach works reasonably well, but can actually become a Trojan horse where the ownership of a web-domain changes and yet the categorization remains the same.

Thus, there exists a need in the art for more advanced approaches, devices and systems for using web-domain information in Internet security processes.

### SUMMARY

Various embodiments provide systems and methods for mitigating security threats due to web-domain characteristic changes.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1C illustrate a network architecture having a network security appliance executing a web-domain re-categorization application is shown in accordance with various embodiments;

FIG. 2 is a flow diagram shows a method in accordance with various embodiments for re-categorizing web-domains; and

FIG. 3 is a flow diagram shows a method in accordance with various embodiments for re-categorizing web-domains triggered by web-domain characterization changes.

### DETAILED DESCRIPTION

Various embodiments provide systems and methods for mitigating security threats due to web-domain characteristic changes.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance”, “network device”, or “network element” generally refers to a device or appliance in virtual or physical form that is operable to perform one or more network or endpoint functions. In some cases, a network appliance may be a database, a network server, computer, mobile phone, or the like. Some network elements may be implemented as general-purpose computers or servers with appropriate software operable to perform the one or more network functions. Other network elements may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance”, “network security device”, or a “network security element” that may reside within the particular network that it is protecting or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views or processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

Some embodiments provide methods that include: determining, by a processing resource, a change in at least one characteristic of a web-domain, wherein the web-domain is identified as having a first status; applying, by the processing resource, a security process to a first network communication based at least in part on the first status; based at least in part on the change in the at least one characteristic of the web-domain, modifying the first status to a second status by the processing resource; and applying, by the processing resource, the security process to a second network communication based at least in part on the second status.

In some instances of the aforementioned embodiments, the methods further include accessing, by the processing resource, the at least one characteristic of the web-domain. In some such instances, accessing the at least one characteristic of the web-domain includes performing a whois query.

In various instances of the aforementioned embodiments, the at least one characteristic of the web-domain includes one or more characteristics from the following list: an administrative contact information for the web-domain, a technical contact information for the web-domain, a date the web domain was created, a date the web-domain last changed, and a name server for the web-domain. In some instances of the aforementioned embodiments, the at least one characteristic of the web-domain is an indication the web-domain is for sale.

In some instances of the aforementioned embodiments, the first status indicates either that the web-domain is malicious, or that the web-domain is safe. In some instances of the aforementioned embodiments, the second status is an indication that the web-domain is unknown.

In various instances of the aforementioned embodiments, modifying the first status to the second status includes: writing the second status to a web-domain security database in relation to the web-domain. In some such instances, applying the security process to the second network communication based at least in part on the second status includes accessing the second status from the web-domain security database.

Other embodiments provide systems for performing network security. Such systems include a processing resource coupled to a non-transitory computer-readable medium. The non-transitory computer-readable medium has stored therein instructions that when executed by the processing resource cause the processing resource to: determine a change in at least one characteristic of a web-domain, wherein the web-domain is identified as having a first status; apply a security process to a first network communication based at least in part on the first status; based at least in part on the change in the at least one characteristic of the web-domain, modify the first status to a second status; and apply the security process to a second network communication based at least in part on the second status.

Yet other embodiments provide non-transitory computer-readable storage media embodying a set of instructions, which when executed by a processing resource, causes the processing resource to: determine a change in at least one characteristic of a web-domain, wherein the web-domain is identified as having a first status; apply a security process to a first network communication based at least in part on the first status; based at least in part on the change in the at least one characteristic of the web-domain, modify the first status to a second status; and apply the security process to a second network communication based at least in part on the second status.

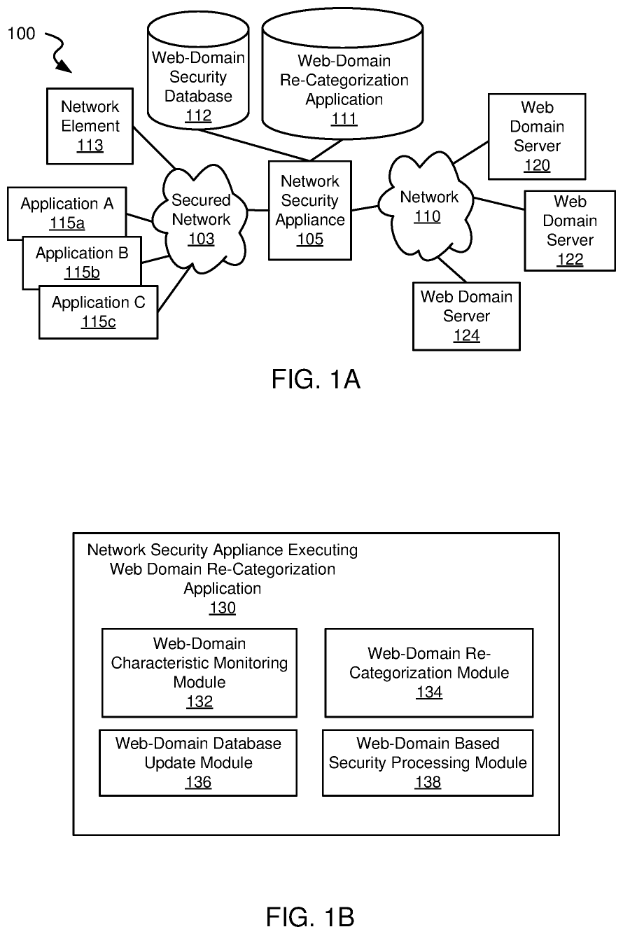

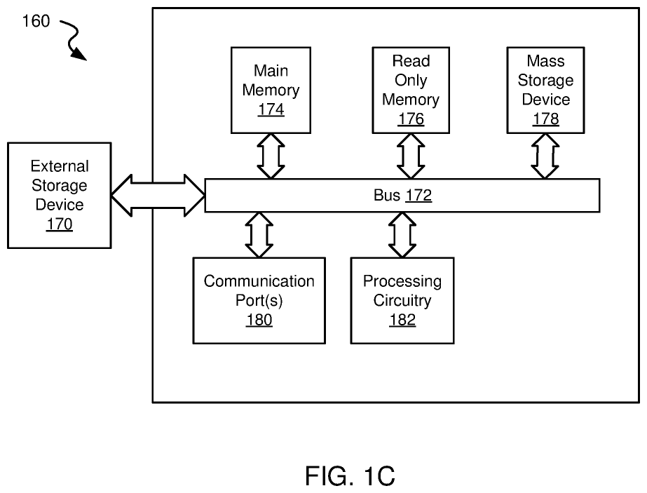

Turning to FIG. 1A, a network architecture 100 having a network security appliance 105 executing a web-domain re-categorization application 111 is shown in accordance with various embodiments. Network security appliance 105 protects a secured network 103. Secured network 103 may be any type of network known in the art. Thus, secured network 103 may be, but is not limited to, a wireless network, a wired network or a combination thereof that can be implemented as one of the various types of networks, such as the Internet, an Intranet, a Local Area Network (LAN), a Wide Area Network (WAN), and the like.

Secured network 103 provides for internetwork communications between network element 113 and applications 115 (i.e., application A 115a, application B 115b, and application C 115c). Network security appliance 105 operates as a gateway between secured network 103 and outside networks (e.g., a network 110). Network 110 may be any type of network known in the art. Thus, network 110 may be, but is not limited to, a wireless network, a wired network or a combination thereof that can be implemented as one of the various types of networks, such as the Internet, an Intranet, a Local Area Network (LAN), a Wide Area Network (WAN), and the like. Network security appliance 105 provides for communications between network element 113 and various web-domain servers (e.g., web-domain servers 120, 122, 124) via network 110.

A web-domain security database 112 is communicably coupled to network security appliance 105 and includes the status of a number of web-domains. The status of the web-domains may indicate, for example, whether a web-domain is a known malicious domain, a known safe domain, or an unknown domain. Further refinement of the status of the web-domains may include, but is not limited to, an indication of the level of maliciousness or safeness of each of the web-domains may be indicated. In operation, network security appliance 105 uses this web-domain status information to control whether information from a given web-domain is allowed to pass into a protected network, whether any access to a given web-domain is allowed, or other network security processes or controls. Use of such web-domain status may be done similar to any approach known in the art for using web-domain based information to govern network security processes.

Execution of web-domain re-categorization application 111 by network security appliance 105 causes an update of web-domain categories or status maintained in web-domain security database 112. This can include monitoring characteristics of one or more web-domains to identify changes that may impact the status or category of a web-domain. In some embodiments, the characteristics of the web-domains that are monitored include: administrative contact information for the web-domain, technical contact information for the web-domain, the date the web domain was created, the date the web-domain last changed, and the name server(s) for the web-domain. In the aforementioned embodiments, the web-domain characteristics may be accessed using a “whois” request commonly used in the art. In yet other embodiments, the characteristics of the web-domains that are monitored include whether the web-domain is identified as being available or for sale. In such embodiments, this information may be accessed by monitoring one or more web-domains where domains as sold such as, for example, “dropcatch.com”. Based upon the disclosure provided herein, one of ordinary skill in the art will recognize a variety of other web-domain characteristics that may be accessed and/or locations or mechanism for which to access the information that may be used in relation to different embodiments. In addition, it is determined whether the characteristic(s) of a web-domain indicate a key change. Where a key change is indicated, the status of the web-domain may be changed to avoid reliance on a prior categorization of the web-domain that may not now reflect the actual situation.

Turning to FIG. 1B, an example implementation of a network security appliance executing a web-domain re-categorization application 130 is shown in accordance with some embodiments. As shown, network security appliance executing web-domain re-categorization application 130 includes a web-domain characteristic monitoring module 132, a web-domain re-categorization module 134, a web-domain database update module 136, and a web-domain based security processing module 138.

Web-domain characteristic monitoring module 132 is configured to determine the current status of one or more characteristics of web-domains included monitored by a network security appliance. In some embodiments, the one or more characteristics is the date the web-domain last changed. In other embodiments, the one or more characteristics include two or more of: administrative contact information for the web-domain, technical contact information for the web-domain, the date the web domain was created, the date the web-domain last changed, and the name server(s) for the web-domain. In the aforementioned embodiments, the web-domain characteristics may be accessed using a “whois query” commonly used in the art. In yet other embodiments, the one or more characteristics is a listing of the web-domain as being available or for sale. In such embodiments, this information may be accessed by monitoring one or more web-domains where domains as sold such as, for example, “dropcatch.com”. Based upon the disclosure provided herein, one of ordinary skill in the art will recognize a variety of other web-domain characteristics that may be accessed and/or locations or mechanism for which to access the information that may be used in relation to different embodiments.

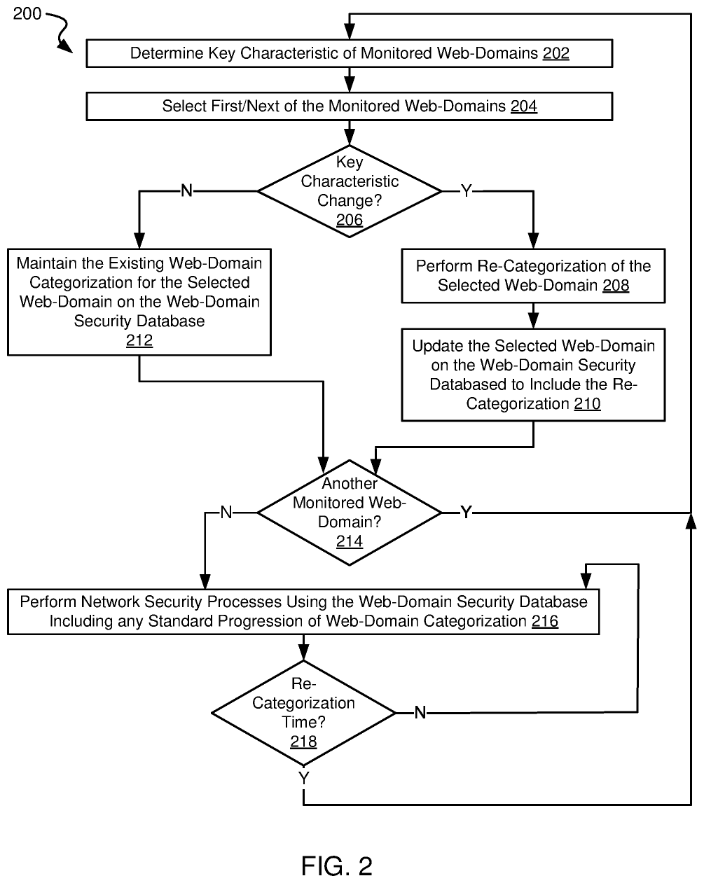

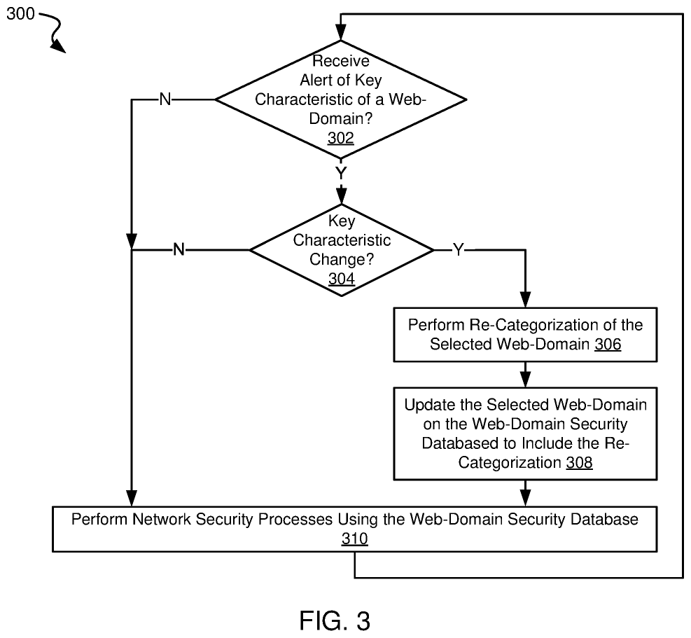

Web-domain re-categorization module 134 is configured to modify the categorization of a web-domain from one status to another. The status of the web-domains may indicate whether a web-domain is a known malicious domain, a known safe domain, or an unknown domain. Further, the level of maliciousness or safeness of each of the web-domains may be indicated. Web-domain re-categorization module 134 may use any status modification process known in the art for modifying the status of a web-domain based upon information received. In addition to the known approaches for modifying web-domain status, web-domain re-categorization module 134 performs a status change whenever a key characteristic change in the web-domain has been detected similar to that discussed below in relation to FIGS. 2-3 below. A key characteristic change may be indicated, for example, when there is a change in one or more of the characteristics of the web-domain identified by web-domain characteristic monitoring module 132. In some embodiments, a particular combination of characteristics must change before a key characteristic change is indicated. Based upon the disclosure provided herein, one of ordinary skill in the art will recognize a variety of characteristics (either one or a combination) of a web-domain that when changed suggest that the web-domain may have experienced a fundamental change, and therefor prior categorization of the web-domain is no longer reliable.

Web-domain database update module 136 is configured to make changes to the web-domain security database either periodically or immediately when a web-domain category changes. Web-domain based security processing module 138 is configured to perform known network security processes relying upon the status or characterization of web-domains is performed using the information maintained in the web-domain security database. Such processes may include, but are not limited to, determining: whether access to a given web-domain is allowed, whether data may be sent to a given web-domain, whether data may be received from a given web-domain, whether a web-domain warning is provided before allowing a transaction to proceed, and/or the modification of the status of a given web-domain in the web-domain security database once the malicious or safe nature of a web-domain becomes more clear.

Turning to FIG. 1C, an example computer system 160 is shown in which or with which embodiments of the present disclosure may be utilized. As shown in FIG. 1C, computer system 160 includes an external storage device 170, a bus 172, a main memory 174, a read-only memory 176, a mass storage device 178, one or more communication ports 180, and one or more processing resources (e.g., processing circuitry 182). In some cases, computer system 160 may be used to implement all or part of network security appliance 105.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25 G, 40 G, and 100 G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g. start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing resources to software system.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 170 can be any kind of external hard-drives, floppy drives, IOMEGA® Zip Drives, Compact Disc- Read Only Memory (CD-ROM), Compact Disc - Rewritable (CD-RW), Digital Video Disk- Read Only Memory (DVD-ROM). Components described above are meant only to show various possibilities. In no way should the aforementioned example computer system limit the scope of the present disclosure.

Turning to FIG. 2, a flow diagram 200 shows a method in accordance with various embodiments for re-categorizing web-domains. Following flow diagram 200, the current status of one or more characteristics of each of the web-domains included in a web-domain security database are determined (block 202). In some embodiments, the one or more characteristics is the date the web-domain last changed. In other embodiments, the one or more characteristics include two or more of: administrative contact information for the web-domain, technical contact information for the web-domain, the date the web domain was created, the date the web-domain last changed, and the name server(s) for the web-domain. In the aforementioned embodiments, the web-domain characteristics may be accessed using a “whois query” commonly used in the art. In yet other embodiments, the one or more characteristics is a listing of the web-domain as being available or for sale. In such embodiments, this information may be accessed by monitoring one or more web-domains where domains as sold such as, for example, “dropcatch.com”. Based upon the disclosure provided herein, one of ordinary skill in the art will recognize a variety of other web-domain characteristics that may be accessed and/or locations or mechanism for which to access the information that may be used in relation to different embodiments.

One of the monitored web-domains is selected for processing (block 204). This may be any of the web-domains for which the one or more characteristics were gathered. For the selected web-domain, it is determined whether a key characteristic change occurred (block 206). A key characteristic change may be any change in the one or more characteristics of the web-domain that would suggest that reliance upon a prior status of the selected web-domain is no longer reliable. For example, in some embodiments, the prior status of a web-domain is no longer considered reliable when a change has occurred in any one of the: administrative contact information for the web-domain, technical contact information for the web-domain, the date the web domain was created, the date the web-domain last changed, and/or the name server(s) for the web-domain. Based upon the disclosure provided herein, one of ordinary skill in the art will recognize which changes in a characteristic or combination of characteristics may be considered a key characteristic change.

Where no key characteristic change is indicated (block 206), the existing web-domain categorization (i.e., the prior status of the web-domain as safe, malicious, or otherwise) is maintained (i.e., not changed) in the web-domain security database (block 212). Alternatively, where a key characteristic change is indicated (block 204), a re-categorization of the selected web-domain is performed (block 208). In some embodiments, such a re-categorization involves changing the category or status of the selected web-domain to “unknown”. After this, prior art processes of investigating a web-domain and applying status changes based upon the investigation may be performed over a period of time while the “unknown” status is used in security processing (i.e., that discussed below in relation to block 216). As such, the aforementioned re-categorization process merely resets the status of the selected web-domain to an initial state from which it may be adjusted over time using prior art processes. In other embodiments, such a re-categorization involves applying prior art processes of investigating a web-domain and applying status changes based upon the investigation may be performed. As such, the re-categorization includes the actual re-categorization of the web-domain and results in a more accurate categorization in place of the initial “unknown” status discussed in relation to the aforementioned embodiment. Once the re-categorization is complete (whether to an “unknown” or to a fully updated status) (block 208), the updated status of the selected web-domain is stored in the web-domain security database (block 210).

It is determined whether another web-domain for which characteristics were accessed remains to be processed (block 214). Where another web-domain remains to be processed (block 214), the next web-domain is selected (block 204) and the processes of blocks 206-214 are repeated for the next selected web-domain. These processes are repeated for each selected web-domain until all web-domains for which characteristics were accessed are processed.

Where no web-domains remain to be processed (block 214), network security processes relying upon the status or characterization of web-domains is performed using the information maintained in the web-domain security database (block 216). These processes may include, but are not limited to, determining: whether access to a given web-domain is allowed, whether data may be sent to a given web-domain, whether data may be received from a given web-domain, whether a web-domain warning is provided before allowing a transaction to proceed, and/or the modification of the status of a given web-domain in the web-domain security database once the malicious or safe nature of a web-domain becomes more clear. Block 216 may include performance of any security processes known in the art.

It is determined whether it is time to review categorization status of the web-domains included in web-domain security database (block 218). In some embodiments the re-categorization is reviewed once per week. Based upon the disclosure provided herein, one of ordinary skill in the art will recognize a variety of time periods that would be appropriate for review in accordance with different embodiments. Where it is time to review the re-categorization (block 218), the processes of blocks 202-214 are repeated. Otherwise the security processing of block 216 continues. Of note, in some embodiments, the security processing of block 216 is performed in parallel to blocks 202-214 using a shadow web-domain security database, and the web-domain security database is only updated once all modifications occurring as a result of blocks 202-214 are complete.

Turning to FIG. 3, a flow diagram 300 shows a method in accordance with various embodiments for re-categorizing web-domains triggered by web-domain characterization changes. In contrast to that discussed above in relation to FIG. 2 where updates to the web-domain security database are done periodically, in the method of flow diagram 300 updates to the web-domain security database are triggered based upon an alert of a change. Following flow diagram 300, it is determined whether an alert of a key characteristic of a web-domain has been received (block 302). Such an alert may be generated by a process that continually monitors changes to web-domains by, for example, continuously generating “whois” requests and comparing results and/or monitoring web-domain sale sites.

Where an alert is received (block 302), it is determined whether the alerted change qualifies as a key characteristic change (block 304). A key characteristic change may be any change in the one or more characteristics of the web-domain that would suggest that reliance upon a prior status of the selected web-domain is no longer reliable. For example, in some embodiments, the prior status of a web-domain is no longer considered reliable when a change has occurred in any one of the: administrative contact information for the web-domain, technical contact information for the web-domain, the date the web domain was created, the date the web-domain last changed, and/or the name server(s) for the web-domain. Based upon the disclosure provided herein, one of ordinary skill in the art will recognize which changes in a characteristic or combination of characteristics may be considered a key characteristic change.

Where the alerted change qualifies as a key characteristic change (block 304), a re-categorization of the web-domain associated with the alert is performed (block 306). In some embodiments, such a re-categorization involves changing the category or status of the selected web-domain to “unknown”. After this, prior art processes of investigating a web-domain and applying status changes based upon the investigation may be performed over a period of time while the “unknown” status is used in security processing (i.e., that discussed below in relation to block 312). As such, the aforementioned re-categorization process merely resets the status of the selected web-domain to an initial state from which it may be adjusted over time using prior art processes. In other embodiments, such a re-categorization involves applying prior art processes of investigating a web-domain and applying status changes based upon the investigation may be performed. As such, the re-categorization includes the actual re-categorization of the web-domain and results in a more accurate categorization in place of the initial “unknown” status discussed in relation to the aforementioned embodiment. Once the re-categorization is complete (whether to an “unknown” or to a fully updated status) (block 306), the updated status of the selected web-domain is stored in the web-domain security database (block 308).

Network security processes relying upon the status or characterization of web-domains is performed using the information maintained in the web-domain security database (block 310). These processes may include, but are not limited to, determining: whether access to a given web-domain is allowed, whether data may be sent to a given web-domain, whether data may be received from a given web-domain, whether a web-domain warning is provided before allowing a transaction to proceed, and/or the modification of the status of a given web-domain in the web-domain security database once the malicious or safe nature of a web-domain becomes more clear. Block 310 may include performance of any security processes known in the art.

In conclusion, the present invention provides for novel systems, devices, and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method, the method comprising:
determining, by a processing resource, a change in at least one characteristic of a web-domain, wherein the web-domain is identified as having a first status;
applying, by the processing resource, a security process to a first network communication based at least in part on the first status;
based at least in part on the change in the at least one characteristic of the web-domain, modifying the first status to a second status by the processing resource; and
applying, by the processing resource, the security process to a second network communication based at least in part on the second status.

2. The method of claim 1, the method further comprising:
accessing, by the processing resource, the at least one characteristic of the web-domain.

3. The method of claim 2, wherein accessing the at least one characteristic of the web-domain includes performing a whois query.

4. The method of claim 1, wherein the at least one characteristic of the web-domain is one or more characteristics selected from a group consisting of: an administrative contact information for the web-domain, a technical contact information for the web-domain, a date the web domain was created, a date the web-domain last changed, and a name server for the web-domain.

5. The method of claim 1, wherein the at least one characteristic of the web-domain is an indication the web-domain is for sale.

6. The method of claim 1, wherein the first status is selected from a group consisting of: an indication that the web-domain is malicious, and an indication that the web-domain is safe.

7. The method of claim 1, wherein the second status is an indication that the web-domain is unknown.

8. The method of claim 1, wherein modifying the first status to the second status includes: writing the second status to a web-domain security database in relation to the web-domain.

9. The method of claim 8, wherein applying the security process to the second network communication based at least in part on the second status includes accessing the second status from the web-domain security database.

10. A system for performing network security, the system comprising:
a processing resource;
a non-transitory computer-readable medium, coupled to the processing resource, having stored therein instructions that when executed by the processing resource cause the processing resource to:
determine a change in at least one characteristic of a web-domain, wherein the web-domain is identified as having a first status;
apply a security process to a first network communication based at least in part on the first status;
based at least in part on the change in the at least one characteristic of the web-domain, modify the first status to a second status; and
apply the security process to a second network communication based at least in part on the second status.

11. The system of claim 10, wherein the instructions that when executed by the processing resource further cause the processing resource to:
access the at least one characteristic of the web-domain.

12. The system of claim 11, wherein accessing the at least one characteristic of the web-domain includes performing a whois query.

13. The system of claim 10, wherein the at least one characteristic of the web-domain is one or more characteristics selected from a group consisting of: an administrative contact information for the web-domain, a technical contact information for the web-domain, a date the web domain was created, a date the web-domain last changed, and a name server for the web-domain.

14. The system of claim 10, wherein the at least one characteristic of the web-domain is an indication the web-domain is for sale.

15. The system of claim 10, wherein the first status is selected from a group consisting of: an indication that the web-domain is malicious, and an indication that the web-domain is safe.

16. The system of claim 10, wherein the second status is an indication that the web-domain is unknown.

17. The system of claim 10, wherein the system further comprises:
a web-domain security database; and
wherein modifying the first status to the second status includes: writing the second status to the web-domain security database in relation to the web-domain.

18. The system of claim 17, wherein applying the security process to the second network communication based at least in part on the second status includes accessing the second status from the web-domain security database.

19. A non-transitory computer-readable storage medium embodying a set of instructions, which when executed by a processing resource, causes the processing resource to:
determine a change in at least one characteristic of a web-domain, wherein the web-domain is identified as having a first status;
apply a security process to a first network communication based at least in part on the first status;
based at least in part on the change in the at least one characteristic of the web-domain, modify the first status to a second status; and
apply the security process to a second network communication based at least in part on the second status.

20. The non-transitory computer-readable storage medium of claim 19, wherein the at least one characteristic of the web-domain is one or more characteristics selected from a group consisting of: an administrative contact information for the web-domain, a technical contact information for the web-domain, a date the web domain was created, a date the web-domain last changed, and a name server for the web-domain.
